(19) United States
(12) Patent Application Publication
(10) Pub. No.: US 2014/0016258 A1
(43) Pub. Date: Jan. 16, 2014

(54) DISPLAY APPARATUS CAPABLE OF ATTACHING PORTABLE TERMINAL

(71) Applicant: Jun Youb Jeong, Uijeongbu-si (KR)

(72) Inventor: Jun Youb Jeong, Uijeongbu-si (KR)

(21) Appl. No.: 13/983,570

(22) PCT Filed: Jan. 16, 2012
(86) PCT No.: PCT/KR2012/000352

§ 371 Date: Aug. 26, 2013

(30) Foreign Application Priority Data
Feb. 10, 2011 (KR) 20-2011-0001132

(51) Int. Cl. G06F 1/16

(52) U.S. Cl. CPC G06F 1/1601
USPC 361/679.26

(57) ABSTRACT

A display apparatus capable of attaching a portable terminal includes: a display unit having sliding protrusions formed on a bottom surface, for displaying a current screen of the portable terminal; and a portable terminal connecting unit having sliding grooves formed on a top surface and combined with the sliding protrusions, being slidingly inserted into a lower portion of the display unit by an associative operation of the sliding protrusions and the sliding grooves, and having an accommodation space formed to accommodate and connect the portable terminal. Therefore, the portable terminal can be controlled using the separate display apparatus connected to the portable terminal, and the portable terminal can be connected to the separate display apparatus without being exposed outside. The separate display apparatus may supply power to the portable terminal when the battery of the portable terminal is discharged.

### TECHNICAL FIELD

The present invention relates to a display apparatus capable of attaching a portable terminal, and more specifically, to a display apparatus capable of combining the portable terminal to a portable terminal connecting unit of the separate display apparatus where a display unit and the portable terminal connecting unit are formed in one piece, displaying and controlling a current screen of the portable terminal on the display unit, and slidingly inserting the portable terminal connecting unit combined with the portable terminal into a lower portion of the display unit.

### BACKGROUND ART

An apparatus for displaying a current screen of a portable terminal on a separate display apparatus generally displays only the current screen of the portable terminal, and thus there is a problem in that the current screen of the portable cannot be controlled through the separate display apparatus.

In addition, since the portable terminal is exposed outside the separate display apparatus combined with the portable terminal, there is a problem in that the portable terminal can be damaged or fail to work correctly.

Furthermore, although the portable terminal is attached to the display apparatus, the portable terminal cannot be used if the battery of the portable terminal is discharged.

### DISCLOSURE OF INVENTION

Technical Problem

Therefore, the present invention has been made in view of the above problems, and it is an object of the present invention to provide a display apparatus capable of attaching a portable terminal. The screen of the portable terminal can be controlled through the separate display apparatus combined with the portable terminal, and the portable terminal can be combined with the separate display apparatus so as not to be exposed outside. The separate display apparatus may supply power to the portable terminal when the battery of the portable terminal is discharged.

Solution to Problem

To accomplish the above object, according to one aspect of the present invention, there is provided a display apparatus capable of attaching a portable terminal, the apparatus comprising: a display unit having sliding protrusions formed on a bottom surface, for displaying a current screen of the portable terminal; and a portable terminal connecting unit having sliding grooves formed on a top surface and combined with the sliding protrusions, being slidingly inserted into a lower portion of the display unit by an associative operation of the sliding protrusions and the sliding grooves, and having an accommodation space formed to accommodate and connect the portable terminal.

The display unit or the portable terminal connecting unit includes a battery unit formed on a bottom surface, for supplying power to the display unit or the portable terminal connecting unit.

The display unit includes: a power button for controlling power supplied by the battery unit to the display unit; a speaker for outputting a sound generated by software driven in the portable terminal; and a volume control button for controlling volume of the sound outputted through the speaker.

The portable terminal connecting unit includes: a connector mounted on the accommodation space and connected to the portable terminal, for bi-directionally transmitting screen data of the portable terminal and the display unit between the portable terminal and the display unit; and a camera hole formed to be correspondent to a position of a camera provided in the portable terminal.

The connector is connected to the battery unit so that the power supplied by the battery unit may be transferred to the portable terminal.

The battery unit is detachable.

Advantageous Effects of Invention

According to a preferred embodiment of the present invention described above, the screen of the portable terminal can be controlled through the separate display apparatus combined with the portable terminal, and the portable terminal can be combined with the separate display apparatus so as not to be exposed outside. The separate display apparatus may supply power to the portable terminal when the battery of the portable terminal is discharged.

### BRIEF DESCRIPTION OF DRAWINGS

The above and other objects, features and advantages of the present invention will be apparent from the following detailed description of the preferred embodiments of the invention in conjunction with the accompanying drawings.

FIG. 1 is a perspective view showing a display apparatus capable of attaching a portable terminal according to an embodiment of the present invention, in which a portable terminal connecting unit is withdrawn from a display unit.

FIG. 2 is a perspective view showing a display apparatus capable of attaching a portable terminal according to an embodiment of the present invention, in which a portable terminal connecting unit is inserted into a display unit.

FIG. 3 is an exploded perspective view showing a display apparatus capable of attaching a portable terminal according to an embodiment of the present invention.

FIG. 4 is a bottom view showing a display apparatus capable of attaching a portable terminal according to an embodiment of the present invention, in which a portable terminal connecting unit is withdrawn from a display unit.

FIG. 5 is a bottom view showing a display apparatus capable of attaching a portable terminal according to an embodiment of the present invention, in which a portable terminal connecting unit is inserted into a display unit.

FIG. 6 is a perspective view showing a display apparatus capable of attaching a portable terminal according to an embodiment of the present invention, in which the portable terminal is accommodated in the display apparatus, and a current screen of the portable terminal is displayed on a display unit.

### MODE FOR THE INVENTION

The preferred embodiments of the invention will be hereafter described in detail, with reference to the accompanying drawings.

<Display Apparatus Capable of Attaching Portable Terminal>

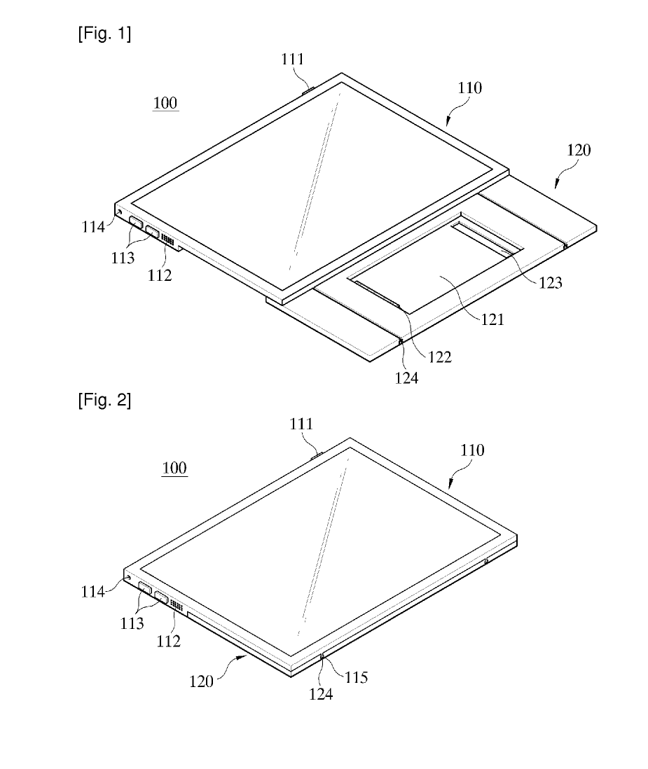

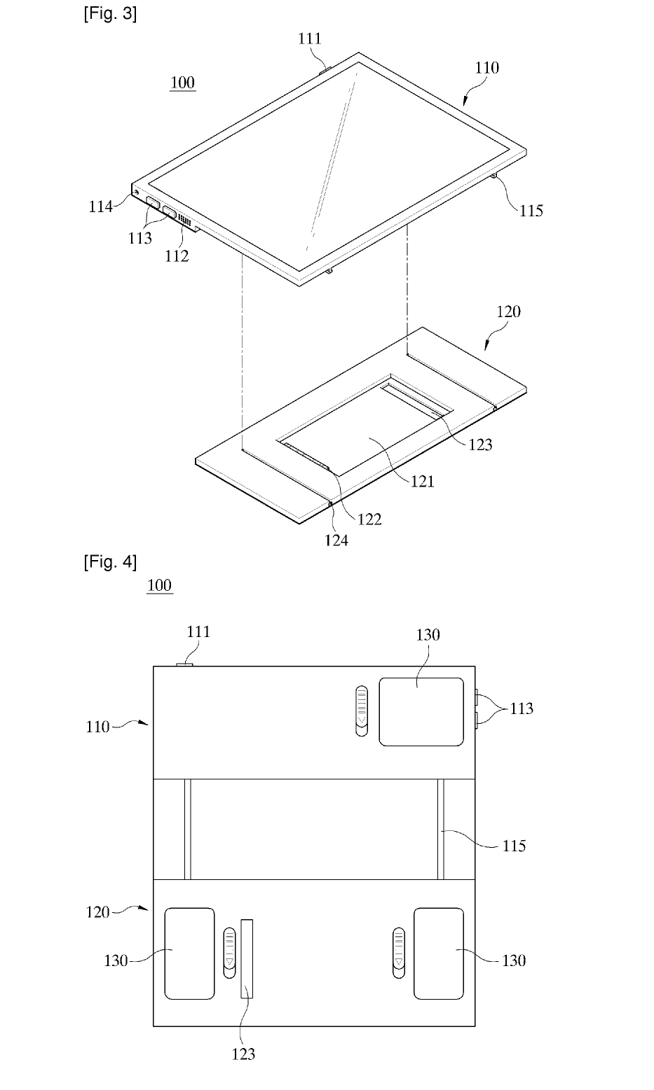

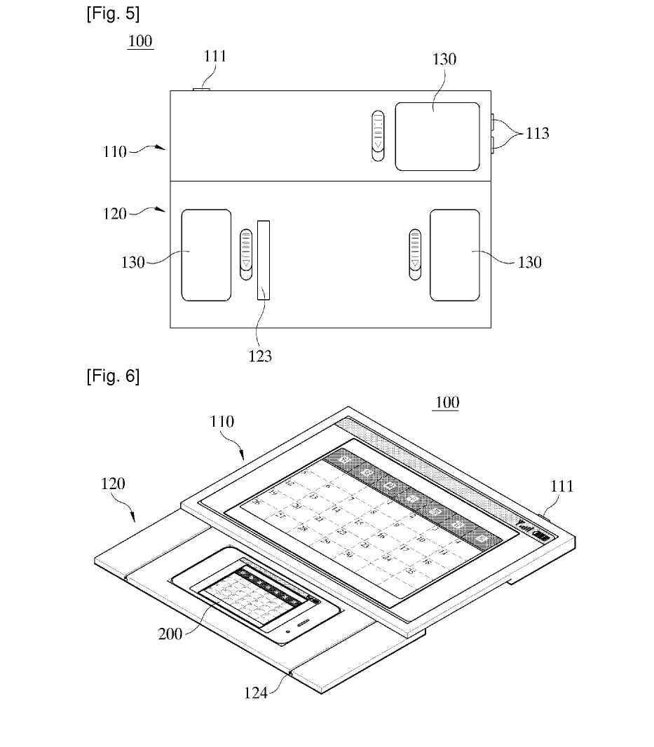

FIG. 1 is a perspective view showing a display apparatus capable of attaching a portable terminal according to an embodiment of the present invention, in which a portable terminal connecting unit is withdrawn from a display unit, FIG. 2 is a perspective view showing a display apparatus capable of attaching a portable terminal according to an embodiment of the present invention, in which a portable terminal connecting unit is inserted into a display unit, FIG. 3 is an exploded perspective view showing a display apparatus capable of attaching a portable terminal according to an embodiment of the present invention, FIG. 4 is a bottom view showing a display apparatus capable of attaching a portable terminal according to an embodiment of the present invention, in which a portable terminal connecting unit is withdrawn from a display unit, FIG. 5 is a bottom view showing a display apparatus capable of attaching a portable terminal according to an embodiment of the present invention, in which a portable terminal connecting unit is inserted into a display unit, and FIG. 6 is a perspective view showing a display apparatus capable of attaching a portable terminal according to an embodiment of the present invention, in which the portable terminal is accommodated in the display apparatus, and a current screen of the portable terminal is displayed on a display unit.

As shown in FIGS. 1 to 6, a display apparatus 100 capable of attaching a portable terminal according to an embodiment of the present invention includes a display unit 110 and a portable terminal connecting unit 120.

Here, the portable terminal 200 combined with the display apparatus 100 capable of attaching a portable terminal includes a cellular phone, a PMP, a smart phone, a PDA, an MP3 player having a crystal liquid display, and the like.

Sliding protrusions 115 are formed on the bottom surface of the display unit 110, and the display unit 110 displays a current screen of the portable terminal 200. The display unit 110 is configured using an LED, an LCD, or an OLED, and the screen displayed on the display unit 110 may be controlled in a capacitive or resistive touch method. In addition, the current screen of the portable terminal 200 displayed on the display unit 110 can be separately handled through the display unit 110, and the current screen of the portable terminal 200 handled through the display unit 110 is transmitted and applied to the portable terminal 200. The display unit 110 described above includes a power button 111, a speaker 112, volume control buttons 113, an earphone insertion hole 114, and a battery unit 130.

The power button 111 controls power supplied to the display unit 110, and the power is turned off using the power button 111 when the display apparatus 100 capable of attaching a portable terminal is not used, and thus it is advantageous in that power of the battery unit 130 described below can be saved.

The speaker 112 outputs a sound generated by software currently driven in the portable terminal 200. Here, the sound outputted through the speaker 112 is not the same as a sound outputted through the speaker of the portable terminal 200, but the sound generated by the software driven in the portable terminal 200 is outputted. Accordingly, the sound generated by the software driven in the portable terminal 200 is outputted through the speaker 112 even when the portable terminal 200 is in a vibration mode or a mute mode. One or more of the speaker 112 may be provided so that various sounds such as a Dolby stereo sound may be outputted.

The volume control buttons 113 control volume of the sound outputted through the speaker 112, and the sound outputted through the speaker 112 can be controlled to the volume of a sound desired by a user. Since a sound outputted through the speaker 112 higher than enough can be prevented, power of the battery unit 130 described below can be saved.

The earphone insertion hole 114 is for connecting a separately provided earphone, and if the earphone is connected to the earphone insertion hole 114, the sound outputted through the speaker 112 is muted and outputted through the earphone. Since the connection relation between the earphone and the earphone insertion hole 114 is generally used in the art, detailed descriptions thereof will be omitted.

The battery unit 130 supplies power to the display unit 110 and to the portable terminal 200 through the portable terminal connecting unit 120 described below. Here, the battery unit 130 is detachably provided on the bottom surface of the display unit 110 so as to be separated from the display unit 110, and thus when the battery unit 130 is discharged, the battery unit 130 can be replaced with a separately provided extra battery unit 130. Therefore, it is advantageous in that the user is free from inconvenience of recharging the battery unit all the time.

The power button 111, the speaker 112, the volume control buttons 113, and the earphone insertion hole 114 described above can be provided at any portion of the display unit 110, and the portions provided with the elements can be changed by simply modifying the design by those skilled in the art. In addition, a general button method or a touch button method can be used for the power button 111 and the volume control buttons 113.

Sliding grooves 124 corresponding to the shape of the sliding protrusion 115 of the display unit 110 are formed on the top surface of the portable terminal connecting unit 120, and the portable terminal connecting unit 120 is slidingly inserted into the lower portion of the display unit 110 by an associative operation of the sliding protrusions 115 of the display unit 110 and the sliding grooves 124. An accommodation space 121 is formed to accommodate and connect the portable terminal 200. Here, the accommodation space 121 is formed at a portion of the portable terminal connecting unit 120 in a size capable of accommodating the portable terminal 200. The portable terminal connecting unit 120 further includes a connector 122, a camera hole 123, the sliding grooves 124, and a battery unit 130.

The connector 122 is combined with a connector receiving terminal of the portable terminal 200 so that data can be transmitted between the portable terminal 200 and the display unit 110. Here, bi-directional communication is allowed between the portable terminal 200 and the display unit 110 connected through the connector 122. That is, data related to the current screen of the portable terminal 200 is transmitted to the display unit 110, and at the same time, data related to handling the current screen of the portable terminal 200 by the user through the display unit 110 is transmitted to the portable terminal 200. In addition, the connector 122 transfers power supplied by the battery unit 130 to the portable terminal 200 so that the portable terminal 200 can be driven and used even when power of the portable terminal 200 connected to the portable terminal connecting unit 120 is discharged. A 30-pin connector, a HDMI connector, or the like may be used as the connector 122.

The camera hole 123 is formed to pass through the bottom surface of the portable terminal connecting unit 120. The camera hole 123 is formed to be correspondent to the position of a camera provided in the portable terminal so that pictures may be photographed using the portable terminal 200 while the portable terminal 200 is connected to the portable terminal connecting unit 120. Here, it is apparent that the position and size of the camera hole 123 vary depending on the type of the portable terminal 200.

The battery unit 130 is positioned on the bottom surface of the portable terminal connecting unit 120 as is described above for the display unit 110. Here, supplying power by the battery unit 130 to the portable terminal 200 is transferring the power supplied by the battery unit 130 to the portable terminal 120 through the connector 122.

According to the present invention, the portable terminal can be controlled using the separate display apparatus connected to the portable terminal, and the portable terminal can be connected to the separate display apparatus without being exposed outside. The separate display apparatus may supply power to the portable terminal when the battery of the portable terminal is discharged.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A display apparatus capable of attaching a portable terminal, the apparatus comprising:
a display unit having sliding protrusions formed on a bottom surface, for displaying a current screen of the portable terminal; and
a portable terminal connecting unit having sliding grooves formed on a top surface and combined with the sliding protrusions, being slidingly inserted into a lower portion of the display unit by an associative operation of the sliding protrusions and the sliding grooves, and having an accommodation space formed to accommodate and connect the portable terminal.

2. The apparatus according to claim 1, wherein the display unit or the portable terminal connecting unit includes a battery unit formed on a bottom surface, for supplying power to the display unit or the portable terminal connecting unit.

3. The apparatus according to claim 1,
wherein the display unit includes:
a power button for controlling power supplied by the battery unit to the display unit;
a speaker for outputting a sound generated by software driven in the portable terminal; and
a volume control button for controlling volume of the sound outputted through the speaker.

4. The apparatus according to claim 1,
wherein the portable terminal connecting unit includes:
a connector mounted on the accommodation space and connected to the portable terminal, for bi-directionally transmitting screen data of the portable terminal and the display unit between the portable terminal and the display unit; and
a camera hole formed to be correspondent, to a position of a camera provided in the portable terminal 200.

5. The apparatus according to claim 1, wherein the connector is connected to the battery unit so that the power supplied by the battery unit may be transferred to the portable terminal.

6. The apparatus according to claim 1, wherein the battery unit is detachable.
